(19) United States
(12) Patent Application Publication
(10) Pub. No.: US 2026/0148493 A1
(43) Pub. Date: May 28, 2026

(54) METHODS AND SYSTEMS FOR ENHANCED GENERATIVE GENEALOGY

(71) Applicant: Treemily Group Inc., Brooklyn, NY (US)

(72) Inventors: Asher Halberstam, Brooklyn, NY (US); Moish Soloway, Hollywood, FL (US); Oleksii Romanenko, Castanea delle Furie (IT); Vadym Bondarenko, Cherkasy (GB); Oleksandr Hlushko, Cherkasy (GB); Ihor Kolesnichenko, Cherkasy (GB)

(21) Appl. No.: 19/289,889

(22) Filed: Aug. 4, 2025

Related U.S. Application Data
(60) Provisional application No. 63/725,698, filed on Nov. 27, 2024.

(51) Int. Cl. G06T 17/00; G06F 16/901; G06T 3/40

(52) U.S. Cl. CPC G06T 17/005; G06F 16/9027; G06T 3/40

(57) ABSTRACT

A method for operating a genealogy system involves rendering family tree data into a family tree image by selecting a family tree generation algorithm based on the data analysis, choosing a polygon for the tree crown shape, calculating radii for nodes representing individuals in the family tree, generating sectors within the polygon, determining the maximum number of levels based on the generations in the data, transforming points to geo data, and placing nodes in the polygon based on the geo data points. The method further involves resizing nodes using a scaling factor, rendering the family tree image, analyzing it with a trained AI model, assigning a score, and displaying the family tree image to a user if the score exceeds a set threshold.

### CROSS REFERENCE TO RELATED APPLICATION

This application claims the benefit of U.S. Provisional Patent Application No. 68/146,320, filed Nov. 27, 2024, the contents of which are hereby incorporated by reference.

### FIELD OF THE DISCLOSURE

Implementations of the disclosure relate to enhancements in AI generation in genealogy searching systems, providing enhanced functionality and technical improvements over existing genealogy computing systems.

### BACKGROUND

Existing methods for generating displays of family trees typically involve creating a family tree by manually adding images and text of relatives to a family tree image. In some cases, family tree image templates exist so a person interested in creating a family tree can manually add relatives to a predefined family tree template. However, due to the extreme variations of relatives from family to family, no one has created an automated way to generate family tree images that can adapt to all of the extreme variations of families.

Some methods for generating family tree images for genealogy systems may involve creating family tree image templates. To accommodate some of the variations (but not all variations) from family to family, a set of family tree image templates needs to include dozens of variations of each template style offered for use. Creating new family tree images templates can take up to a year of manual labor, which may include designing, integrating, and testing the family tree image template varieties. One template design may include designing 50 template varieties to accommodate some of the potential variations of families. Once the template varieties are created, the template varieties can be integrated into code, and then undergo testing if the templates are used in digital family tree system. Moreover, conventional methods of creating family trees lack flexibility in customizing the appearance of the family tree, such as the shape of the tree crown or the arrangement of family members within a selected the tree crown. Because families can have so many variations, it is not possible to create enough suitable family tree image template variations to accommodate the differences that exist between families. As a result, existing methods cannot adapt to the specific characteristics of family tree data being input and family tree images cannot be satisfactorily rendered because they are applied to predetermined templates that generally don't match with the family tree data. Consequently, there is a need for an improved method to create family trees.

### BRIEF SUMMARY

In some aspects, the techniques described herein relate to a method of operating a genealogy system, including: receiving a selection of family tree data to render into a family tree image; determining a family tree generation algorithm to use from a plurality of family tree generation algorithms based on an analysis of the family tree data; selecting a polygon to use for a shape of a tree crown image; calculating radii for a plurality of nodes, wherein a node of the plurality of nodes corresponds to a person in the family tree data; calculating and generating a plurality of sectors within the polygon; calculating a maximum quantity of levels based on the quantity of generations in the family tree data; generating points around the polygon; transforming the points to geo data points; transforming the tree crown image to a geo data polygon; determining geo data points that are within the geo data polygon; generating a plurality of levels for the polygon based on the quantity of generations in the family tree data and the geo data polygon area, wherein the sectors intersect with the plurality of levels; placing the plurality of nodes in at least some of the polygons on the geo data points; resizing the plurality of nodes using a scaling factor based on the quantities of nodes of the plurality of nodes placed in the sectors and levels of the geo data polygon; rendering the family tree data into the family tree image using the plurality of nodes; visually analyzing the rendered family tree image with a trained AI model; determining a score for the rendered family tree image with the trained AI model; and displaying the rendered family tree image to a user if the score for the rendered family tree image is above a predetermined threshold.

In some aspects, the techniques described herein relate to a method, wherein determining a family tree generation algorithm from a plurality of family tree generation algorithms based on an analysis of the family tree data further includes: determining whether an anomaly exists in the family tree data.

In some aspects, the techniques described herein relate to a method, wherein determining a family tree generation algorithm from a plurality of family tree generation algorithms based on an analysis of the family tree data further includes: determining that an anomaly exists in the family tree data; determining that the anomaly exists over a predetermined threshold of generations in the family tree data; and selecting a family tree generation algorithm suitable for the determined anomaly.

In some aspects, the techniques described herein relate to a method, wherein the determined anomaly is a plurality of generations in the family tree data of singular descendants.

In some aspects, the techniques described herein relate to a method, wherein the quantity of sectors correspond to family generations contained in the received family tree data.

In some aspects, the techniques described herein relate to a method 1, wherein the radius for a node of the plurality of nodes is calculated by: r=√(Node Area/π); where Node Area=Area of the polygon*Coverage/Nodes quantity.

In some aspects, the techniques described herein relate to a method, wherein rendering family tree data in the family tree image using the plurality of nodes further includes: adding images and names of people from the family tree data to associated node locations in the family tree image.

In some aspects, the techniques described herein relate to a method, further including: rendering a plurality of family tree images, wherein the plurality of family tree images are different from each other; visually analyzing the plurality of rendered family tree image with the trained AI model; determining scores for the plurality of rendered family tree image with the trained AI model; and selecting a subset of the plurality of rendered family tree images based on the determined scores; and displaying the subset of the plurality of rendered family tree images to a user for selection.

In some aspects, the techniques described herein relate to a method, wherein the plurality of family tree images are different from each other based on changes to the node locations within the polygon.

In some aspects, the techniques described herein relate to a method, wherein the generated points around the polygon are randomly generated.

In some aspects, the techniques described herein relate to a system for operating a genealogy system including: a processor; and a memory device that stores a plurality of instructions, which when executed by the processor, causes the processor to be configured to: receive a selection of family tree data to render into a family tree image; determine a family tree generation algorithm to use from a plurality of family tree generation algorithms based on an analysis of the family tree data; select a polygon to use for a shape of a tree crown image; calculate radii for a plurality of nodes, wherein a node of the plurality of nodes corresponds to a person in the family tree data; calculate and generating a plurality of sectors within the polygon; calculate a maximum quantity of levels based on the quantity of generations in the family tree data; generate points around the polygon; transform the points to geo data points; transform the tree crown image to a geo data polygon; determine geo data points that are within the geo data polygon; generate a plurality of levels for the polygon based on the quantity of generations in the family tree data and the geo data polygon area, wherein the sectors intersect with the plurality of levels; place the plurality of nodes on at least some of the geo data points in the polygon; resize the plurality of nodes using a scaling factor based on the quantities of nodes of the plurality of nodes placed in the sectors and levels of the geo data polygon; render the family tree data into the family tree image using the plurality of nodes; visually analyze the rendered family tree image with a trained AI model; determine a score for the rendered family tree image with the trained AI model; and display the rendered family tree image to a user if the score for the rendered family tree image is above a predetermined threshold.

In some aspects, the techniques described herein relate to a system, wherein when determining a family tree generation algorithm from a plurality of family tree generation algorithms based on an analysis of the family tree data, the plurality of instructions, when executed, further configure the processor to: determine whether an anomaly exists in the family tree data.

In some aspects, the techniques described herein relate to a system, when determining a family tree generation algorithm from a plurality of family tree generation algorithms based on an analysis of the family tree data, the plurality of instructions, when executed, further configure the processor to: determine that an anomaly exists in the family tree data; determine that the anomaly exists over a predetermined threshold of generations in the family tree data; and select a family tree generation algorithm suitable for the determined anomaly.

In some aspects, the techniques described herein relate to a system, wherein the determined anomaly is a plurality of generations in the family tree data of singular descendants.

In some aspects, the techniques described herein relate to a system, wherein the quantity of sectors correspond to family generations contained in the received family tree data.

In some aspects, the techniques described herein relate to a system, wherein the radius for a node of the plurality of nodes is calculated by: r=√(Node Area/π); and where Node Area =Area of the polygon*Coverage/Nodes quantity.

In some aspects, the techniques described herein relate to a system, wherein when rendering family tree data in the family tree image using the plurality of nodes, the plurality of instructions, when executed, further configure the processor to: add images and names of people from the family tree data to associated node locations in the family tree image.

In some aspects, the techniques described herein relate to a system, wherein the plurality of instructions, when executed, further configure the processor to: render a plurality of family tree images, wherein the plurality of family tree images are different from each other; visually analyze the plurality of rendered family tree image with the trained AI model; determine scores for the plurality of rendered family tree image with the trained AI model; and select a subset of the plurality of rendered family tree images based on the determined scores; and display the subset of the plurality of rendered family tree images to a user for selection.

In some aspects, the techniques described herein relate to a system, wherein the plurality of family tree images are different from each other based on changes to the node locations within the polygon.

In some aspects, the techniques described herein relate to a system, wherein the generated points around the polygon are randomly generated.

In some aspects, the techniques described herein relate to a method of operating a genealogy system, including: receiving a selection of family tree data to render into a family tree image; selecting a polygon to use for a shape of a tree crown image; calculating radii for a plurality of nodes, wherein a node of the plurality of nodes corresponds to a person in the family tree data; calculating and generating a plurality of sectors within the polygon; calculating a maximum quantity of levels based on the quantity of generations in the family tree data; randomly determining points for placement of the nodes within the polygon; placing the plurality of nodes on at least some of the determined points in the polygon; resizing the plurality of nodes using a scaling factor based on the quantities of nodes of the plurality of nodes placed in sectors and levels of the polygon; rendering the family tree data into the family tree image using the plurality of nodes; visually analyzing the rendered family tree image with a trained AI model; determining a score for the rendered family tree image with the trained AI model; and displaying one or more rendered family tree images to a user if the score for the one or more rendered family tree images is above a predetermined threshold.

### BRIEF DESCRIPTION OF THE FIGURES

FIG. 1 is a block diagram that describes an improved genealogy system according to some implementations of the present disclosure.

FIG. 2A, FIG. 2B, and FIG. 2C are flowcharts of an example process 200 of a genealogy system.

FIG. 3A and FIG. 3B are flowcharts of an example process 300 of a genealogy system.

FIG. 4 illustrates an example computer system 400 for executing client or server operations for a genealogy system.

FIG. 5A, FIG. 5B, FIG. 5C, FIG. 5D, FIG. 5E, and FIG. 5F are example illustrations of generating and placing nodes within a polygon for a family tree image generation.

### DETAILED DESCRIPTION

The systems and methods described herein provide a new and improved genealogy family tree rendering system.

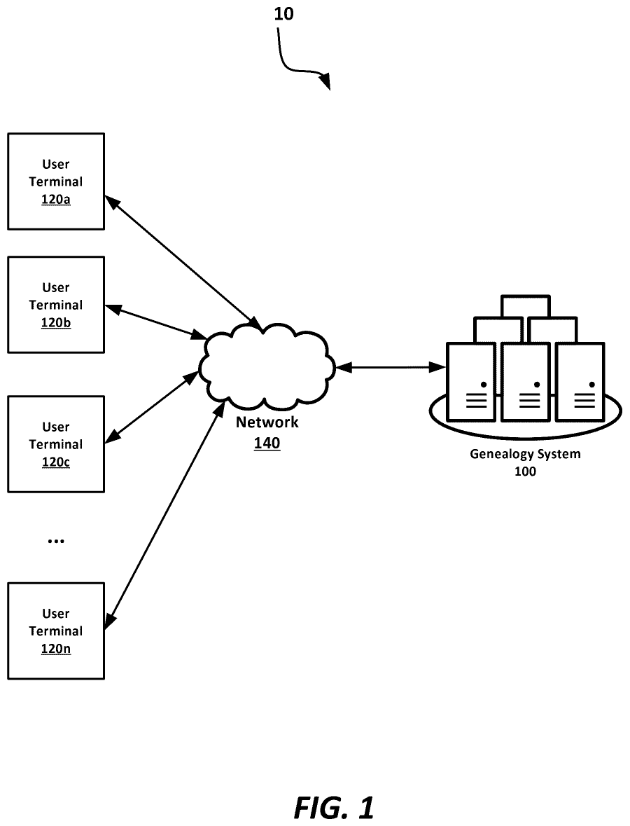

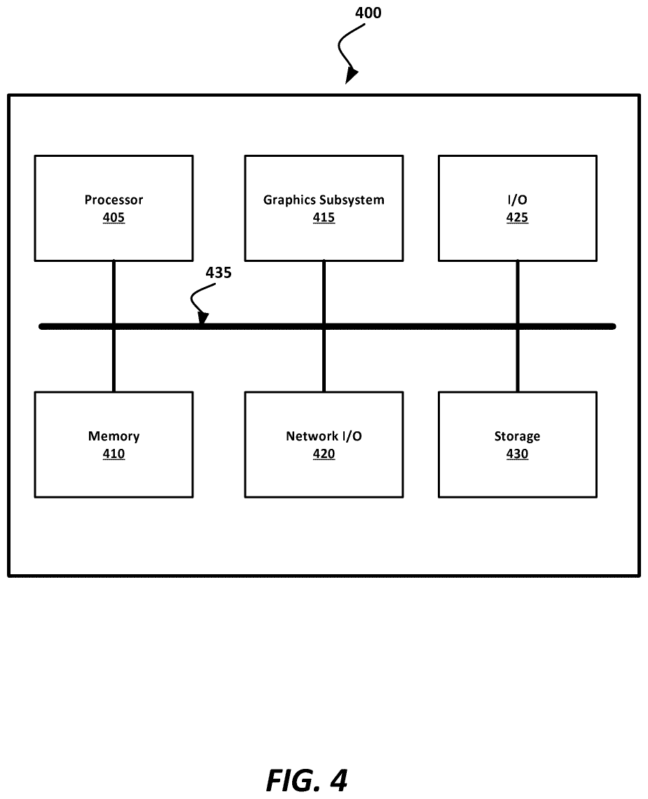

FIG. 1 is a block diagram that describes an improved system 10, according to some implementations of the present disclosure. In some implementations, system 10 may include an improved genealogy system 100. In some implementations, the genealogy system 100 may include one or more specialized servers that generate and render family tree images and evaluate the rendered family tree images using AI to determine the highest quality family tree images from among a plurality of generated and rendered family tree images as described in the instant disclosure. The servers in genealogy system 100 may include computing devices, such as the computing system 400 further described in FIG. 4 and configured with specialized instructions to execute the generation, rendering, and evaluation of family tree images as described herein. In some implementations, the system 10 may include one or more user terminals, such as user terminal 120a, user terminal 120b, user terminal 120c, up through user terminal 120n. The system 10 may include any suitable number of user terminals. The user terminals in system 10 may include computing devices, such as the computing system 400 further described in FIG. 4. User terminals may be configured to send and receive data to the genealogy system 100 via network 140. Network 140 can be the Internet or one or more other suitable networks.

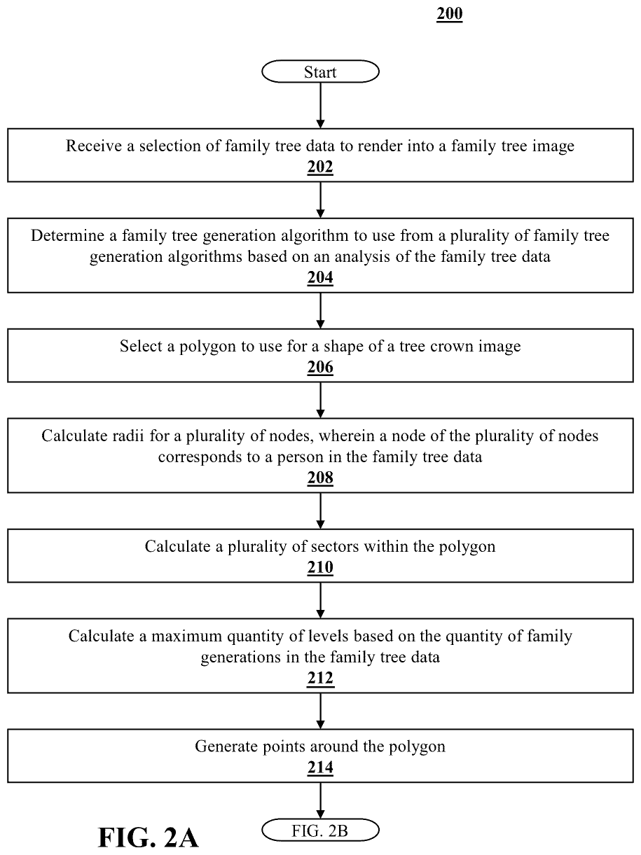

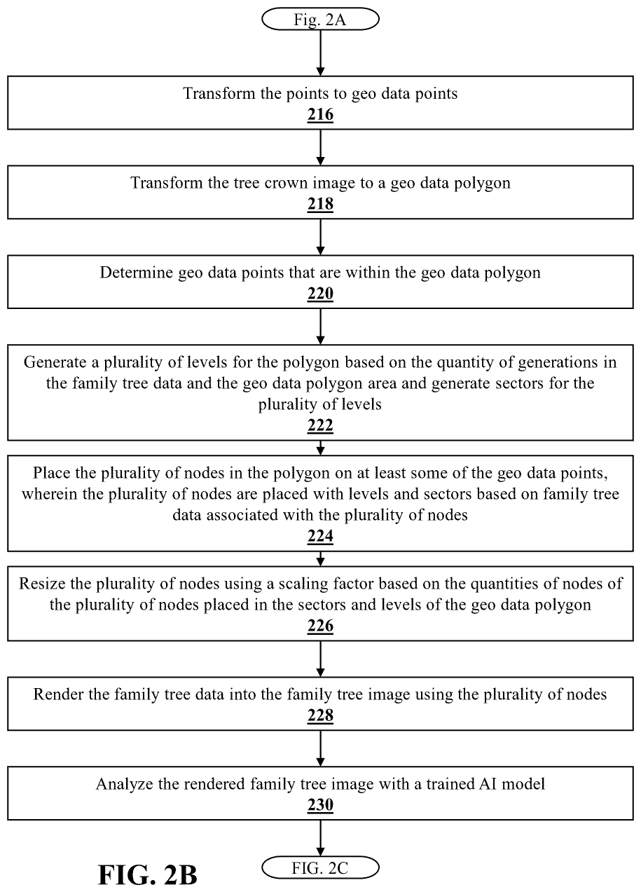

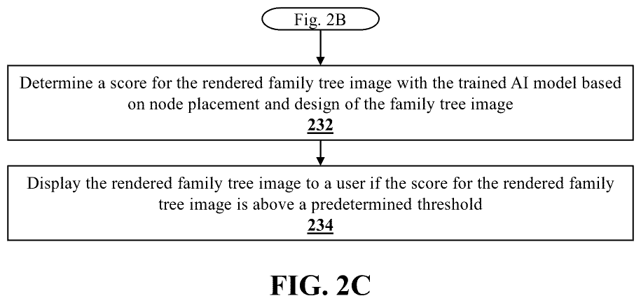

FIG. 2A-FIG. 2C are flowcharts of an example process 200. In some implementations, one or more process blocks of FIG. 2A-FIG. 2C may be performed by one or more processors of genealogy system 100. In some implementations, the one or more processors of genealogy system 100 can be a processor, such as a processor 405 specially programmed to execute one or more functions of process 200 in a computing system 400. Genealogy system 100 may include one or more computing systems 400.

As shown in FIG. 2A, process 200 may include receiving a selection of family tree data to render into a family tree image (block 202). For example, a user at a user terminal 120n may select a family tree to generate associated with their family tree data. The selection of the family tree data can be sent to genealogy system 100 through network 140 for processing. In some implementations, the processing may include generating and rendering one or more images representing the user's family tree based on the user's selected family tree data.

As also shown in FIG. 2A, process 200 may include determining a family tree generation algorithm to use from a plurality of family tree generation algorithms based on an analysis of the family tree data (block 204). Family tree data can vary greatly from family to family. Ancestors and descendants in a family tree are rarely the same from family to family. The variations between family trees tends greatly increase as family tree data includes more and more generations. In some implementations, some data for some family trees may include a long line of singular descendants based on unknown family tree information or for other reasons. Due to variations in family tree data, the genealogy system 100 may need to employ one or more different algorithms to create visually balanced and commercially desirable outputs of rendered family tree images, wherein individuals are placed in correct locations relative to their generation within the family tree. As a result, in some implementations, genealogy system 100 may determine one or more family tree generation algorithms to use for the selected family tree data. In some implementations, one family tree generation algorithm may be created to deal with family trees with a first lower threshold of family members in a family tree. In some implementations, a second family tree generation algorithm may be created to deal with family trees with a second threshold of family members in a family tree, wherein the second threshold of family members is greater than the first lower threshold of family members in a family tree. In some implementations, the first lower threshold can be 12 family members. However, the first lower threshold can be any suitable number. In some implementations, the second threshold of family members can be 13 or more family members; provided however, the second threshold of family members can by any suitable number.

In some implementations, determining a family tree generation algorithm from a plurality of family tree generation algorithms based on an analysis of the family tree data may further include determining whether an anomaly exists in the family tree data. In some implementations, an anomaly can be defined as a generation with a single descendant. If there are many generations with a single descendant in the selected family tree data, the resulting family tree may have few or no branches. The placement of people on a generated and rendered family tree image may need to be displayed in a serpentine fashion rather than along branches of a tree. In some implementations, an anomaly in family tree data can be defined differently. In some implementations, genealogy system 100 may track one or more different anomalies. In some implementations, if an anomaly is determined to exist in the family tree data, then genealogy system 100 may select a particular family tree generation algorithm capable of best generating and rendering family tree images with the family tree data determined to include an anomaly. In some implementations, the genealogy system 100 may use further analysis before determining to use a family tree generation algorithm that can properly handle family tree data with an anomaly. In some implementations, genealogy system 100 may analyze the duration of anomaly across generations of family tree data. For example, genealogy system 100 may analyze family tree data to determine whether the anomaly exists over a predetermined threshold of generations in the family tree data. In some implementations, the predetermined threshold can be three or more generations; provided however, the predetermined threshold can be any suitable number. For example, if genealogy system 100 determines that an anomaly exists over three generations of a family in the selected family tree data, the genealogy system 100 may (e.g., using a processor such as processor 405) select a family tree generation algorithm that will provide the best generation and images of the family tree based on the family tree data with the anomaly. In some implementations, genealogy system 100 may use a combination of one or more algorithms to process different generations of the family tree data to generate and render family tree images.

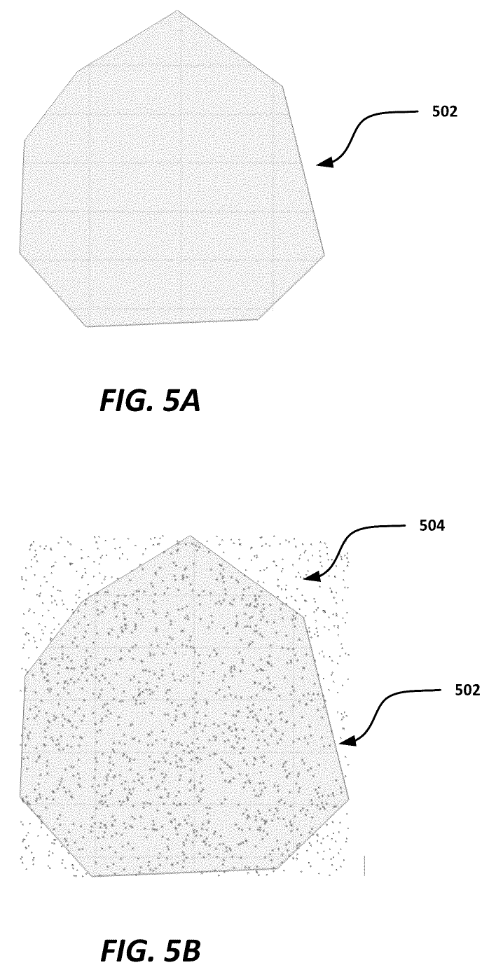

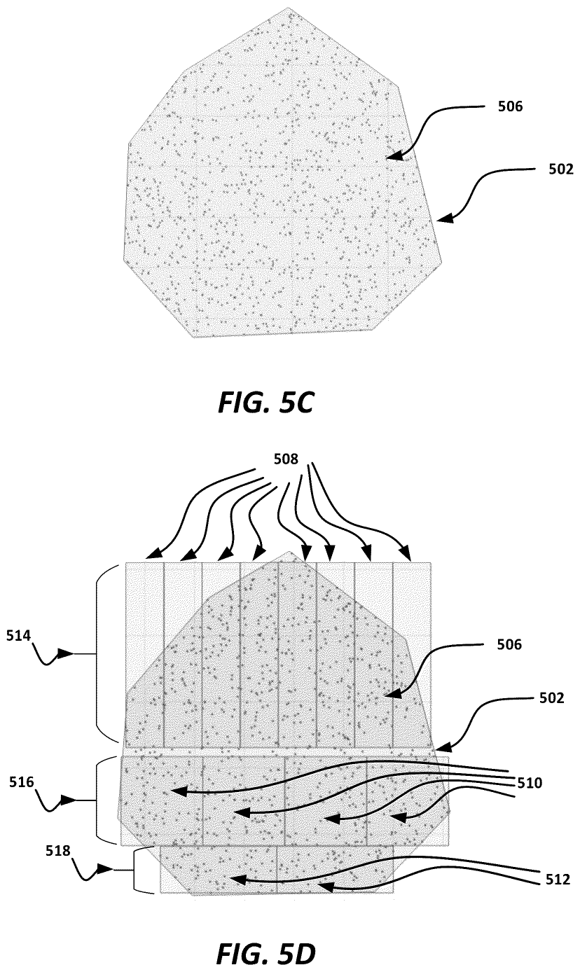

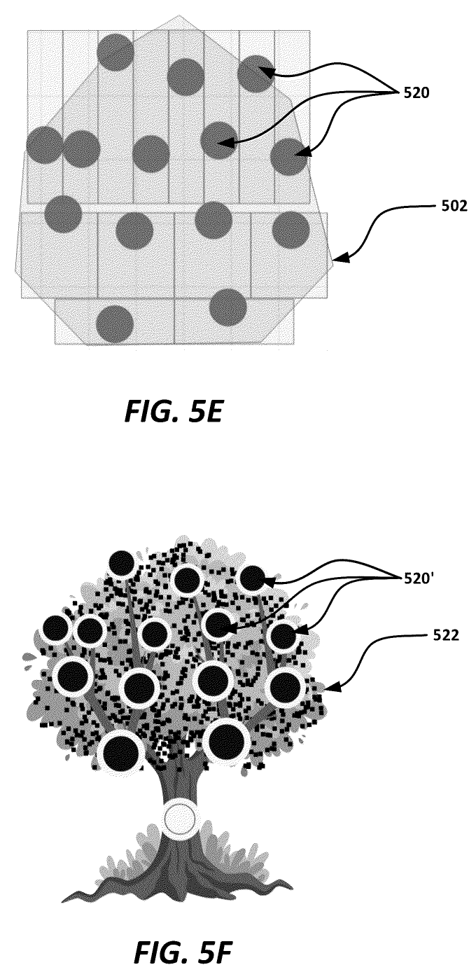

As further shown in FIG. 2A, process 200 may include selecting a polygon to use for a shape of a tree crown image (block 206). FIG. 5A illustrates a polygon 502 that can be selected as substantially confirming to a tree crown image. For example, if a user selected a particular tree crown from a plurality of tree crowns for use to generate and render family tree images, the user may provide this selection to genealogy system 100 through user terminal 120n and network 140. Genealogy system 100 may select a polygon that corresponds to the shape of the selected tree crown image. As an example, a user may have selected to have family tree data rendered on a tree crown shape as shown in FIG. 5F. Genealogy system 100 may select a polygon to use that closely resembles the shape of the tree crown shown in FIG. 5F.

As also shown in FIG. 2A, process 200 may include calculating radii for a plurality of nodes, where a node of the plurality of nodes corresponds to a person in the family tree data (block 208). For example, genealogy system may determine the quantity of individuals in the selected family tree data to determine the quantity of nodes. The nodes, once generated and placed in the polygon, represent the location where a person will be shown in the rendered family tree. In some implementations, the genealogy system 100 calculates an initial radius for one or more of the nodes. In some implementations, the size of the nodes can be equal. In some implementations, the size of the nodes may vary. In some implementations, the size of the nodes for one or more generations of a family is different from one or more other generations of a family in the family tree data. For example, in some implementations, a node for grandparent may have a larger radius than a node for a direct descendant of the grandparent and grandchildren. Likewise, in some implementations, a parent may have a larger radius node than a node for a direct child of the parent, while the radius of the node for the parent's parent (e.g., the grandparent of the direct child) is larger. In some implementations, nodes for one or more generations in a family can be equal. In some implementations, the size differences between generations can be varied to highlight one generation over another generation in a family tree. In some implementations, the radius for a node of the plurality of nodes is calculated by: r=√(Node Area/π); where Node Area=Area of the polygon*Coverage/Nodes quantity. In some implementations, Coverage is a predetermined value that is used to help fine tune and adjust the Node Area calculation, which ultimately can alter the placement and layout of the nodes. In some implementations, Coverage is a dynamically generated value that is used to help fine tune and adjust the Node Area calculation, wherein the value can be determined in several ways, such as based on a determination of node placement or prior node placement. In some implementations, as will be discussed below, the initial radius calculated for one or more nodes may be adjusted later based on the placement of the nodes within the polygon. An example of some nodes placed in a polygon 502 is represented by the nodes 520 in FIG. 5E.

As further shown in FIG. 2A, process 200 may include calculating a plurality of sectors within the polygon (block 210). In some implementations, the sectors are vertical segments determined within the polygon. For example, genealogy system may calculate the quantity of vertical segments (e.g., sectors) that are approximately the width of the one or more node diameters within the area of the polygon. In some implementations, the genealogy system 100 may use the sectors as part of a placement guide to determine where to place one or more nodes determined for the family tree data within the polygon. In some implementations, the size and width of sectors may vary depending on the diameters and quantity of the nodes that will be placed within the sectors. In some implementations, an example of generated sectors are shown in FIG. 5D. Sectors 508, sectors 510, and sectors 512 are shown in FIG. 5D. In some implementations, the sectors may be generated at a later time in the process 200.

As also shown in FIG. 2A, process 200 may include calculating a maximum quantity of levels (block 212). In some implementations, the maximum quantity of levels is based on the quantity of generations in the selected family tree data. For example, if the selected family tree data includes three generations of a family, genealogy system 100 may determine that the maximum quantity of levels for the family tree is three. In some implementations, nodes will be placed in a particular level depending on the generation of the family members that are associated with the nodes. In some implementations, the quantity of generated sectors for a particular family generation is based on the quantity of nodes (e.g., family members) at a level within the polygon. In some implementations, an example of generated levels are shown in FIG. 5D. Level 514, level 516, and level 518 are shown in FIG. 5C. As shown in example of FIG. 5D, the levels have different quantities of sectors.

As further shown in FIG. 2A, process 200 may include generating points within and around the polygon (block 214). For example, genealogy system may randomly generate points within and around the polygon. The genealogy system 100 may randomly generate the points within a boundary area that contains the polygon. FIG. 5B illustrates randomly generated points 504 within and around the polygon 502. At least some of the points 504 will be used, along with the levels and sectors, to determine where to place nodes in the polygon in some implementations. In some implementations, the points can be predetermined. In some implementations, the quantity of points generated for the polygon is based on the quantity of nodes that will be placed within the polygon. For example, in some implementations, if the selected family tree data includes <30 nodes, then genealogy system 100 may generate 1.5 k points in and around the polygon. In some implementations, if the selected family tree data includes between >30<100 nodes, then genealogy system 100 may generate 2.5 k points in and around the polygon. In some implementations, if the selected family tree data includes between >100<150 nodes, then genealogy system 100 may generate 5 k points in and around the polygon. In some implementations, if the selected family tree data includes between >150 nodes, then genealogy system 100 may generate 25 k points in and around the polygon. In some implementations, the density of the points generated is random in and around the polygon. In some implementations, the process to generate and render family tree images is performed multiple times for one set of family data. Among other features, the randomness of the points enables the genealogy system 100 to provide variation in the placement of nodes for the different rendered family tree images while attempting to achieve commercially appropriate rendered family tree images that are analyzed and scored by an AI subsystem. In some implementations, the coordinates of the generated points are determined in a first coordinate system. In some implementations, the first coordinate system is cartesian coordinates. In alternative implementations, the locations of generated points can be determined using other coordinate systems.

In some implementations, the first coordinate system for the generated points is converted into a second coordinate system. As also shown in FIG. 2B, process 200 may include transforming the points generated in block 214 to geo data points (block 216). In some implementations, process 200 may transfer cartesian coordinates for the points into geo data coordinates for the points. In some implementations, the geo data points are used to improve the processing speed of rendering the family tree images. As further shown in FIG. 2B, process 200 may include transforming the tree crown image to a geo data polygon (block 218).

As also shown in FIG. 2B, process 200 may include determining geo data points that are within the geo data polygon (block 220). In implementations using geo data coordinates for the points and geo data coordinates for the polygon, the efficiency of processor 200 determining geo data points that are within the geo data polygon can be improved by 10x over determining points that are within the polygon when the coordinates for the points and polygon are in cartesian coordinates. In some implementations, this is accomplished by comparing the boundary area with the randomly generated points with the geo data polygon area. In some implementations, genealogy system 100 may remove the generated points that are not within the geo data polygon area. An example of this process is illustrated in FIG. 5C. Specifically, FIG. 5C shows an implementation where the points 504 that are spread throughout the boundary area have been reduced to geo data points 506 that are contained within the geo data polygon area. In some implementations, the genealogy system 100 may further convert the remaining geo data polygon area and geo data points to a format that can be used to render the family tree image.

As further shown in FIG. 2B, process 200 may include generating a plurality of levels for the polygon based on the max quantity of levels previously calculated for the quantity of generations in the family tree data and the geo data polygon area (block 222). In some implementations, the process 200 may also include generating sectors for one or more of the plurality of generated levels, wherein the sectors for a level may correspond to the quantity of nodes that will be placed within a particular level. In some implementations, genealogy system 100 may further refine the shape of the geo data polygon area at one or more of the levels to better match with the selected tree crown image that will be used in the rendered family tree image. In some implementations, this refinement of the shape of the geo data polygon area at a level will increase the accuracy of node placement within a particular level of the geo data polygon area.

As also shown in FIG. 2B, process 200 may include placing the plurality of nodes in the polygon on the geo data points (block 224). An example of the node placement can be seen in FIG. 5E, where nodes 520 are placed within levels and sectors of the geo data polygon. In some implementations, the placement of the plurality of nodes will include placing nodes on geo data points that are within an appropriate level and sector for a node. For example, if a node is associated with a grandparent that is the beginning of a family tree, the genealogy system 100 may place node for that grandparent on a geo data point at the bottom most level of the polygon and within one of the sectors of the bottom most level of the polygon. For example, the genealogy system 100 may place a node for the grandparent in level 518 and one of sectors 512 in polygon 502 from FIG. 5D. If a node is associated with a parent (a direct descendent of the grandparent), the genealogy system 100 may place node for that parent on a geo data point at the next level up from the bottom most level of the polygon and within one of the sectors of the next level up from the bottom most level of the polygon. For example, the genealogy system 100 may place a node for the parent in level 516 and one of sectors 510 in polygon 502 from FIG. 5D. If a node is associated with a child (a direct descendent of the parent and grandchild of the grandparent), the genealogy system 100 may place node for that child on a geo data point at the level above the level for the parent and within one of the sectors of the such level of the polygon. For example, the genealogy system 100 may place a node for the child in level 514 and one of sectors 508 in polygon 502 from FIG. 5D.

As further shown in FIG. 2B, process 200 may include resizing the plurality of nodes using a scaling factor based on the quantities of nodes of the plurality of nodes placed in the sectors and levels of the geo data polygon (block 226).

As also shown in FIG. 2B, process 200 may include rendering the family tree data into the family tree image using the plurality of nodes (block 228). For example, genealogy system may add the tree and crown image to the nodes as well as add information from the selected family tree data to appropriate nodes from the family tree data. The information added to the nodes may include pictures of people as well as other associated information (name, date of birth, etc.). An example of this rendering can be found in FIG. 5F. An image of the tree and crown 522 is combined with nodes 520′.

In some implementations, the process at block 204—block 228 may be repeated a multiple times. In some implementations, the process at block 204—block 228 may be repeated 4 times, 50 times, 200 times, or some other suitable quantity of times. In this manner, genealogy system 100 can create many variations of the family tree image (where variations are introduced in part by the randomly generated points within the polygon and placing nodes on these randomly generated points). In some implementations, genealogy system 100 can further introduce variations in the node layout by forcing at least a predetermined difference between node spacing. For example, genealogy system 100 may cause nodes placement to include at least 5% difference from the prior generated family tree image. In some implementations, genealogy system 100 may alter node placement after the nodes are initially placed in the geo data polygon.

As further shown in FIG. 2B, process 200 may include visually analyzing the rendered family tree image with an AI system (block 230). For example, genealogy system 100 may include an AI system that is trained on visually satisfactory family tree images. The AI model may be trained to look for issues such as balanced nodes within a level, balanced nodes within a sector, possible mistake (e.g., nodes appearing in levels that do not make sense). As also shown in FIG. 2C, process 200 may include determining a score for the rendered family tree image with the trained AI model (block 232). As further shown in FIG. 2C, process 200 may include displaying the rendered family tree image to a user if the score for the rendered family tree image is above a predetermined threshold (block 234). As noted above, the genealogy system 100 may include generating several rendered family tree images. One or more of these family tree images may be determined as suitable because they have scores above the predetermined threshold. In such instances, genealogy system 100 may provide a plurality of rendered family tree images to a user. In some implementations, genealogy system 100 may transmit the one or more suitable rendered family tree images to user terminal 120n through network 140 for review. In some implementations, genealogy system 100 may enable the user to purchase one or more of the suitable rendered family tree images. If the user is unsatisfied with the provided family tree images, the user may cause genealogy system 100 to rerun process 200 until the user is satisfied with a provided family tree image.

Although FIG. 2A-FIG. 2C show example blocks of process 200, in some implementations, process 200 may include additional blocks, fewer blocks, different blocks, or differently arranged blocks than those depicted in FIG. 2A-FIG. 2C. Additionally, or alternatively, two or more of the blocks of process 200 may be performed in parallel.

It should be appreciated that by automating the generation and rendering of family tree images and using AI to determine the most appropriate rendered family tree images, the genealogy system 100 eliminates the need to create family tree image templates, a process that can take months to create. The genealogy system 100 can create several or 100s of family tree images in seconds or less. Moreover, process 200 employed by genealogy system 100 enables more accurate and balanced family tree images than are possible using predefined family tree image templates.

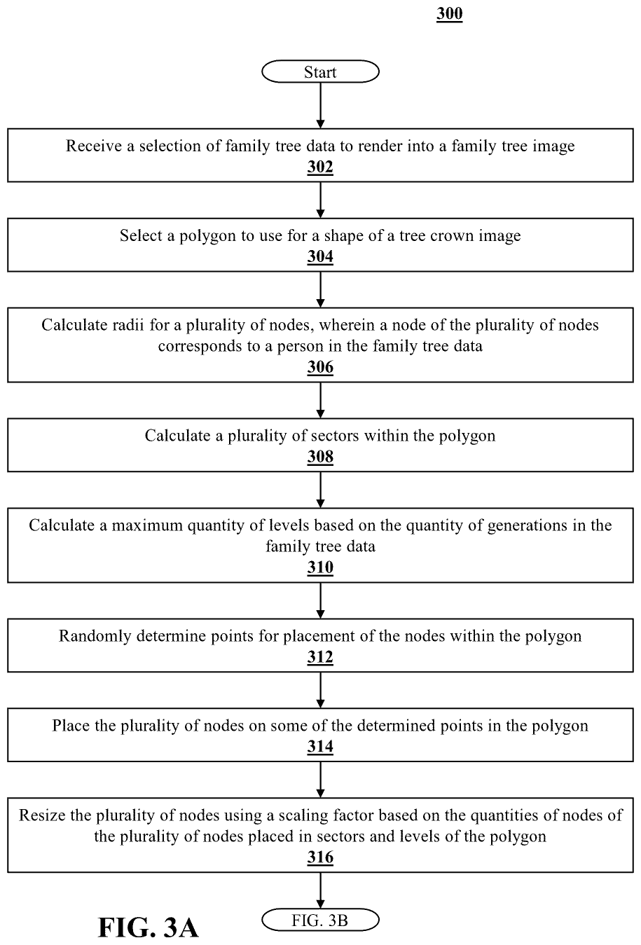

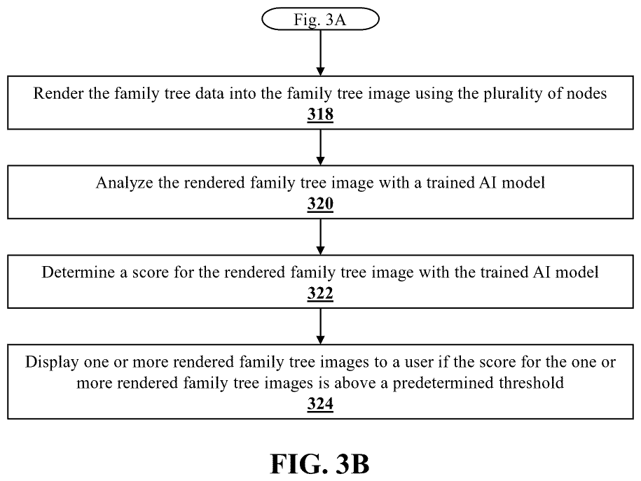

FIG. 3A and FIG. 3B are flowcharts of an example process 300. In some implementations, one or more process blocks of FIG. 3A and FIG. 3B may be performed one or more processors of genealogy system 100. In some implementations, the one or more processors of genealogy system 100 can be a processor, such as a processor 405 specially programmed to execute one or more functions of process 300 in a computing system 400. It should be appreciated that process 300 is similar to process 200, but include fewer blocks than described in process 200. One or more of the features described in connection with process 200 can be included in the process 300.

As shown in FIG. 3A, process 300 may include receiving a selection of family tree data to render into a family tree image (block 302).

As also shown in FIG. 3A, process 300 may include selecting a polygon to use for a shape of a tree crown image (block 304).

As further shown in FIG. 3A, process 300 may include calculating radii for a plurality of nodes, where a node of the plurality of nodes corresponds to a person in the family tree data (block 306).

As also shown in FIG. 3A, process 300 may include calculating and generating a plurality of sectors within the polygon (block 308).

As further shown in FIG. 3A, process 300 may include calculating a maximum quantity of levels based on the quantity of generations in the family tree data (block 310).

As also shown in FIG. 3A, process 300 may include randomly determining points for placement of the nodes within the polygon (block 312).

As further shown in FIG. 3A, process 300 may include placing the plurality of nodes on the determined points in the polygon (block 314).

As also shown in FIG. 3A, process 300 may include resizing the plurality of nodes using a scaling factor based on the quantities of nodes of the plurality of nodes placed in sectors and levels of the polygon (block 316).

As further shown in FIG. 3B, process 300 may include rendering the family tree data into the family tree image using the plurality of nodes (block 318).

As also shown in FIG. 3B, process 300 may include visually analyzing the rendered family tree image with a trained AI model (block 320).

As further shown in FIG. 3B, process 300 may include determining a score for the rendered family tree image with the trained AI model (block 322).

As also shown in FIG. 3B, process 300 may include displaying one or more rendered family tree images to an user if the score for the one or more rendered family tree images is above a predetermined threshold (block 324).

Although FIG. 3A and FIG. 3B shows example blocks of process 300, in some implementations, process 300 may include additional blocks, fewer blocks, different blocks, or differently arranged blocks than those depicted in FIG. 3A and FIG. 3B. Additionally, or alternatively, two or more of the blocks of process 300 may be performed in parallel.

FIG. 4 illustrates an example computer system 400 for executing client or server operations. For example, computer system 400 may execute process 200 and/or process 300. In some implementations, the example computer system 400 may execute a client application, a server side application for performing the instant disclosure (e.g., a genealogy system).

The example computer system 400 includes a processor 405, a memory 410, a graphical subsystem 415, a network i/o 420, general i/o 425, and a storage 430 that communicate and operate via a connection 435. The connection 435 can be a physical connection via a bus, or a direct connection into processor 405, such as in a chipset architecture. The connection 435 can also be a virtual connection, networked connection, or logical connection.

The processor 405 reads machine instructions that are loaded into the memory 410 and executes an operating system for executing applications within frameworks provided by the operating system. That is, the processor 405 can include any general-purpose processor and a hardware service or software service, which are stored in memory 410, and configured to control processor 405 as well as a special-purpose processor where software instructions are incorporated into the actual processor design. The processor 405 may be a completely self-contained computing system, containing multiple cores or processors, a bus, memory controller, cache, etc. A multi-core processor may be symmetric or asymmetric.

The processor 405 controls the memory 410 to store instructions, user data, operating system content, and other content that cannot be stored within the processor 405 internally (e.g., within the various caches). The processor 405 may also control a graphical subsystem 415 (e.g., a graphical processor) that outputs graphical content to a display. In some example, the graphical subsystem 415 may be integral within the processor 405. In yet another example, the display may be integral with the computer system 400 (e.g., a laptop, a tablet, a phone, etc.). In some example, the graphical subsystem 415 may be integral with the processor 405 and form an accelerated processing unit (APU).

The graphical subsystem 415 may be optimized to perform floating point operations such as graphical computations, and may be configured to execute other operations in place of the processor 405. For example, controlled by instructions to perform mathematical operations optimized for floating point math. For example, the processor 405 may allocate instructions to the graphical subsystem 415 for operations that are optimized for the graphical subsystem 415. For instance, the graphical subsystem 415 may execute operations related to genealogy searching and matching operations, and vector math. The results may be returned to the processor 405. In another example, the application executing in the processor 405 may provide instructions to cause the processor 405 to request the graphical subsystem 415 to perform the operations. In other examples, the graphical subsystem 415 may return the processing results to another computer system (e.g., distributed computing).

The processor 405 may also control a network i/o 420 for transmitting and receiving data using a plurality of wireless channels and at least one communication standard (e.g., Wi-Fi, Bluetooth®, one or more cellular standards (e.g., 4G, 5G, etc.), or a satellite communication network. The network i/o 420 may wirelessly connect to a network to connect to servers or other service providers. The network i/o 420 may also be connected to a network via a physical (i.e., circuit) connection. The network i/o 420 may also directly connect to local electronic devices using other suitable communication technologies.

The processor 405 may also control an i/o 425 that connects with one or more external devices for communication. The i/o 425 is any suitable interface that forms a communication connection and can be implemented by any suitable interface (e.g., universal serial bus (USB), serial cable, and so forth). In some implementations, the one or more external devices can receive data from the i/o 425 to process the data or perform functions for different applications executing in the processor 405. For example, the external device may be another display device, a musical instrument, a computer interface device (e.g., a keyboard, a mouse, etc.), an audio device (e.g., an analog-to-digital converter (ADC), a digital-to-analog converter (DAC)), a storage device for storing content, an authentication device, an external network interface, a printer, and so forth.

The storage 430 can be a non-volatile memory device and can be a hard disk or other types of computer readable media which can store data that are accessible by a computer, such as flash memory, solid state memory devices, an electro-mechanical data storage such as a hard disk drive (HDD), optical storage medium, cartridges, random access memories (RAMs), read only memory (ROM), and/or some combination of these devices. However, when mentioned, non-transitory computer-readable storage media expressly exclude media such as energy, carrier signals, electromagnetic waves, and signals per se.

The storage 430 can include software services, servers, services, etc., that when the code that defines such software is executed by the processor 405, it causes the system to perform a function. In some implementations, a hardware service that performs a particular function can include the software component stored in a computer-readable medium in connection with the necessary hardware components, such as processor 405, external devices, etc., to carry out the function.

It should be appreciated that the forgoing improved family tree image generation are technological improvements to computing systems enabling faster and more efficient genealogy systems for end users.

Clause 1. A method of operating a genealogy system, comprising: receiving a selection of family tree data to render into a family tree image; determining a family tree generation algorithm to use from a plurality of family tree generation algorithms based on an analysis of the family tree data; selecting a polygon to use for a shape of a tree crown image; calculating radii for a plurality of nodes, wherein a node of the plurality of nodes corresponds to a person in the family tree data; calculating and generating a plurality of sectors within the polygon; calculating a maximum quantity of levels based on the quantity of generations in the family tree data; generating points around the polygon; transforming the points to geo data points; transforming the tree crown image to a geo data polygon; determining geo data points that are within the geo data polygon; generating a plurality of levels for the polygon based on the quantity of generations in the family tree data and the geo data polygon area, wherein the sectors intersect with the plurality of levels; placing the plurality of nodes in the polygon on at least some of the geo data points; resizing the plurality of nodes using a scaling factor based on the quantities of nodes of the plurality of nodes placed in the sectors and levels of the geo data polygon; rendering the family tree data into the family tree image using the plurality of nodes; visually analyzing the rendered family tree image with a trained AI model; determining a score for the rendered family tree image with the trained AI model; and displaying the rendered family tree image to a user if the score for the rendered family tree image is above a predetermined threshold.

Clause 2. The method of operating a genealogy system of clause 1, wherein determining a family tree generation algorithm from a plurality of family tree generation algorithms based on an analysis of the family tree data further comprises: determining whether an anomaly exists in the family tree data.

Clause 3. The method of operating a genealogy system of clause 1, wherein determining a family tree generation algorithm from a plurality of family tree generation algorithms based on an analysis of the family tree data further comprises: determining that an anomaly exists in the family tree data; determining that the anomaly exists over a predetermined threshold of generations in the family tree data; and selecting a family tree generation algorithm suitable for the determined anomaly.

Clause 4. The method of operating a genealogy system of clause 3, wherein the determined anomaly is a plurality of generations in the family tree data of singular descendants.

Clause 5. The method of operating a genealogy system of clause 1, wherein the quantity of sectors correspond to family generations contained in the received family tree data.

Clause 6. The method of operating a genealogy system of clause 1, wherein the radius for a node of the plurality of nodes is calculated by: r=√(Node Area/π); where Node Area=Area of the polygon*Coverage/Nodes quantity.

Clause 7. The method of operating a genealogy system of clause 1, wherein rendering family tree data in the family tree image using the plurality of nodes further comprises: adding images and names of people from the family tree data to associated node locations in the family tree image.

Clause 8. The method of operating a genealogy system of clause 1, further comprising: rendering a plurality of family tree images, wherein the plurality of family tree images are different from each other; visually analyzing the plurality of rendered family tree image with the trained AI model; determining scores for the plurality of rendered family tree image with the trained AI model; and selecting a subset of the plurality of rendered family tree images based on the determined scores; and displaying the subset of the plurality of rendered family tree images to a user for selection.

Clause 9. The method of operating a genealogy system of clause 8, wherein the plurality of family tree images are different from each other based on changes to the node locations within the polygon.

Clause 10. The method of operating a genealogy system of clause 1, wherein the generated points around the polygon are randomly generated.

Clause 11. A system for operating a genealogy system comprising: a processor; and a memory device that stores a plurality of instructions, which when executed by the processor, causes the processor to be configured to: receive a selection of family tree data to render into a family tree image; determine a family tree generation algorithm to use from a plurality of family tree generation algorithms based on an analysis of the family tree data; select a polygon to use for a shape of a tree crown image; calculate radii for a plurality of nodes, wherein a node of the plurality of nodes corresponds to a person in the family tree data; calculate and generating a plurality of sectors within the polygon; calculate a maximum quantity of levels based on the quantity of generations in the family tree data; generate points around the polygon; transform the points to geo data points; transform the tree crown image to a geo data polygon; determine geo data points that are within the geo data polygon; generate a plurality of levels for the polygon based on the quantity of generations in the family tree data and the geo data polygon area, wherein the sectors intersect with the plurality of levels; place the plurality of nodes on at least some of the geo data points in the polygon; resize the plurality of nodes using a scaling factor based on the quantities of nodes of the plurality of nodes placed in the sectors and levels of the geo data polygon; render the family tree data into the family tree image using the plurality of nodes; visually analyze the rendered family tree image with a trained AI model; determine a score for the rendered family tree image with the trained AI model; and display the rendered family tree image to a user if the score for the rendered family tree image is above a predetermined threshold.

Clause 12. The system of clause 11, wherein when determining a family tree generation algorithm from a plurality of family tree generation algorithms based on an analysis of the family tree data, the plurality of instructions, when executed, further configure the processor to: determine whether an anomaly exists in the family tree data.

Clause 13. The system of clause 11, when determining a family tree generation algorithm from a plurality of family tree generation algorithms based on an analysis of the family tree data, the plurality of instructions, when executed, further configure the processor to: determine that an anomaly exists in the family tree data; determine that the anomaly exists over a predetermined threshold of generations in the family tree data; and select a family tree generation algorithm suitable for the determined anomaly.

Clause 14. The system of clause 13, wherein the determined anomaly is a plurality of generations in the family tree data of singular descendants.

Clause 15. The system of clause 11, wherein the quantity of sectors correspond to family generations contained in the received family tree data.

Clause 16. The system of clause 11, wherein the radius for a node of the plurality of nodes is calculated by: r=√(Node Area/π); and where Node Area=Area of the polygon* Coverage/Nodes quantity.

Clause 17. The system of clause 11, wherein when rendering family tree data in the family tree image using the plurality of nodes, the plurality of instructions, when executed, further configure the processor to: add images and names of people from the family tree data to associated node locations in the family tree image.

Clause 18. The system of clause 11, wherein the plurality of instructions, when executed, further configure the processor to: render a plurality of family tree images, wherein the plurality of family tree images are different from each other; visually analyze the plurality of rendered family tree image with the trained AI model; determine scores for the plurality of rendered family tree image with the trained AI model; and select a subset of the plurality of rendered family tree images based on the determined scores; and display the subset of the plurality of rendered family tree images to a user for selection.

Clause 19. The system of clause 18, wherein the plurality of family tree images are different from each other based on changes to the node locations within the polygon.

Clause 20. The system of clause 11, wherein the generated points around the polygon are randomly generated.

Clause 21. A method of operating a genealogy system, comprising: receiving a selection of family tree data to render into a family tree image; selecting a polygon to use for a shape of a tree crown image; calculating radii for a plurality of nodes, wherein a node of the plurality of nodes corresponds to a person in the family tree data; calculating and generating a plurality of sectors within the polygon; calculating a maximum quantity of levels based on the quantity of generations in the family tree data; randomly determining points for placement of the nodes within the polygon; placing the plurality of nodes on a plurality of the determined points in the polygon; resizing the plurality of nodes using a scaling factor based on the quantities of nodes of the plurality of nodes placed in sectors and levels of the polygon; rendering the family tree data into the family tree image using the plurality of nodes; visually analyzing the rendered family tree image with a trained AI model; determining a score for the rendered family tree image with the trained AI model; and displaying one or more rendered family tree images to a user if the score for the one or more rendered family tree images is above a predetermined threshold.

The present disclosure is not to be limited in terms of the particular implementations described in this application, which are intended as illustrations of various aspects. Moreover, the various disclosed implementations can be interchangeably used with each other, unless otherwise noted. Many modifications and variations can be made without departing from its spirit and scope, as will be apparent to those skilled in the art. Functionally equivalent methods and apparatuses within the scope of the disclosure, in addition to those enumerated herein will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is also to be understood that the terminology used herein is for the purpose of describing particular implementations only, and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” In addition, where features or aspects of the disclosure are described in terms of Markush groups, those skilled in the art will recognize that the disclosure is also thereby described in terms of any individual member or subgroup of members of the Markush group.

Several implementations have been described. Various modifications may be made without departing from the spirit and scope of the description. For example, various forms of the flow charts shown above may be used, with steps re-ordered, added, or removed. Accordingly, other implementations are within the scope of the following claims.

What is claimed:

1. A method of operating a genealogy system, comprising:
receiving a selection of family tree data to render into a family tree image;
determining a family tree generation algorithm to use from a plurality of family tree generation algorithms based on an analysis of the family tree data;
selecting a polygon to use for a shape of a tree crown image;
calculating radii for a plurality of nodes, wherein a node of the plurality of nodes corresponds to a person in the family tree data;
calculating and generating a plurality of sectors within the polygon;
calculating a maximum quantity of levels based on the quantity of generations in the family tree data;
generating points around the polygon;
transforming the points to geo data points;
transforming the tree crown image to a geo data polygon;
determining geo data points that are within the geo data polygon;
generating a plurality of levels for the polygon based on the quantity of generations in the family tree data and the geo data polygon, wherein the sectors intersect with the plurality of levels;
placing the plurality of nodes in the polygon on at least some of the geo data points;
resizing the plurality of nodes using a scaling factor based on the quantities of nodes of the plurality of nodes placed in the sectors and levels of the geo data polygon;
rendering the family tree data into the family tree image using the plurality of nodes;
visually analyzing the rendered family tree image with a trained AI model;
determining a score for the rendered family tree image with the trained AI model; and
displaying the rendered family tree image to a user if the score for the rendered family tree image is above a predetermined threshold.

2. The method of operating a genealogy system of claim 1, wherein determining a family tree generation algorithm from a plurality of family tree generation algorithms based on an analysis of the family tree data further comprises:
determining whether an anomaly exists in the family tree data.

3. The method of operating a genealogy system of claim 1, wherein determining a family tree generation algorithm from a plurality of family tree generation algorithms based on an analysis of the family tree data further comprises:
determining that an anomaly exists in the family tree data;
determining that the anomaly exists over a predetermined threshold of generations in the family tree data; and
selecting a family tree generation algorithm suitable for the determined anomaly.

4. The method of operating a genealogy system of claim 3, wherein the determined anomaly is a plurality of generations in the family tree data of singular descendants.

5. The method of operating a genealogy system of claim 1, wherein the quantity of sectors correspond to family generations contained in the received family tree data.

6. The method of operating a genealogy system of claim 1, wherein a radius for a node of the plurality of nodes is calculated by:
radius=√(Node Area/π); and
where Node Area=(Area of a polygon*Coverage)/Nodes quantity.

7. The method of operating a genealogy system of claim 1, wherein rendering family tree data in the family tree image using the plurality of nodes further comprises:
adding images and names of people from the family tree data to associated node locations in the family tree image.

8. The method of operating a genealogy system of claim 1, further comprising:
rendering a plurality of family tree images, wherein the plurality of family tree images are different from each other;
visually analyzing the plurality of rendered family tree image with the trained AI model;
determining scores for the plurality of rendered family tree image with the trained AI model; and
selecting a subset of the plurality of rendered family tree images based on the determined scores;
displaying the subset of the plurality of rendered family tree images to a user for selection.

9. The method of operating a genealogy system of claim 8, wherein the plurality of family tree images are different from each other based on changes to node locations within the polygon.

10. The method of operating a genealogy system of claim 1, wherein the generated points around the polygon are randomly generated.

11. A system for operating a genealogy system comprising:
a processor; and
a memory device that stores a plurality of instructions, which when executed by the processor, causes the processor to be configured to:
receive a selection of family tree data to render into a family tree image;
determine a family tree generation algorithm to use from a plurality of family tree generation algorithms based on an analysis of the family tree data;
select a polygon to use for a shape of a tree crown image;
calculate radii for a plurality of nodes, wherein a node of the plurality of nodes corresponds to a person in the family tree data;
calculate and generating a plurality of sectors within the polygon;
calculate a maximum quantity of levels based on the quantity of generations in the family tree data;
generate points around the polygon;
transform the points to geo data points;
transform the tree crown image to a geo data polygon;
determine geo data points that are within the geo data polygon;
generate a plurality of levels for the polygon based on the quantity of generations in the family tree data and the geo data polygon, wherein the sectors intersect with the plurality of levels;
place the plurality of nodes on at least some of the geo data points in the polygon;
resize the plurality of nodes using a scaling factor based on the quantities of nodes of the plurality of nodes placed in the sectors and levels of the geo data polygon;
render the family tree data into the family tree image using the plurality of nodes;
visually analyze the rendered family tree image with a trained AI model;
determine a score for the rendered family tree image with the trained AI model; and
display the rendered family tree image to a user if the score for the rendered family tree image is above a predetermined threshold.

12. The system of claim 11, wherein when determining a family tree generation algorithm from a plurality of family tree generation algorithms based on an analysis of the family tree data, the plurality of instructions, when executed, further configure the processor to:
determine whether an anomaly exists in the family tree data.

13. The system of claim 11, when determining a family tree generation algorithm from a plurality of family tree generation algorithms based on an analysis of the family tree data, the plurality of instructions, when executed, further configure the processor to:
determine that an anomaly exists in the family tree data;
determine that the anomaly exists over a predetermined threshold of generations in the family tree data; and
select a family tree generation algorithm suitable for the determined anomaly.

14. The system of claim 13, wherein the determined anomaly is a plurality of generations in the family tree data of singular descendants.

15. The system of claim 11, wherein the quantity of sectors correspond to family generations contained in the received family tree data.

16. The system of claim 11, wherein a radius for a node of the plurality of nodes is calculated by:
radius=√(Node Area/π); and
where Node Area=(Area of a polygon*Coverage)/Nodes quantity.

17. The system of claim 11, wherein when rendering family tree data in the family tree image using the plurality of nodes, the plurality of instructions, when executed, further configure the processor to:
add images and names of people from the family tree data to associated node locations in the family tree image.

18. The system of claim 11, wherein the plurality of instructions, when executed, further configure the processor to:
render a plurality of family tree images, wherein the plurality of family tree images are different from each other;
visually analyze the plurality of rendered family tree image with the trained AI model;
determine scores for the plurality of rendered family tree image with the trained AI model;
select a subset of the plurality of rendered family tree images based on the determined scores; and
display the subset of the plurality of rendered family tree images to a user for selection.

19. The system of claim 18, wherein the plurality of family tree images are different from each other based on changes to node locations within the polygon.

20. A method of operating a genealogy system, comprising:
receiving a selection of family tree data to render into a family tree image;
selecting a polygon to use for a shape of a tree crown image;
calculating radii for a plurality of nodes, wherein a node of the plurality of nodes corresponds to a person in the family tree data;
calculating and generating a plurality of sectors within the polygon;
calculating a maximum quantity of levels based on the quantity of generations in the family tree data;
randomly determining points for placement of the nodes within the polygon;
placing the plurality of nodes on a plurality of the determined points in the polygon;
resizing the plurality of nodes using a scaling factor based on the quantities of nodes of the plurality of nodes placed in sectors and levels of the polygon;
rendering the family tree data into the family tree image using the plurality of nodes;
visually analyzing the rendered family tree image with a trained AI model;
determining a score for the rendered family tree image with the trained AI model; and
displaying one or more rendered family tree images to a user if the score for the one or more rendered family tree images is above a predetermined threshold.
